(19) United States
(12) Patent Application Publication
(10) Pub. No.: US 2006/0115191 A1
(43) Pub. Date: Jun. 1, 2006

(54) Spindle motor having hydrodynamic pressure bearing

(75) Inventor: Ho Lee, Kyungki-do (KR)

Correspondence Address: LOWE HAUPTMAN GILMAN AND BERNER, LLP, 1700 DIAGONAL ROAD, SUITE 300 /310, ALEXANDRIA, VA, 22314, US

(73) Assignee: Samsung Electro-Mechanics Co., Ltd., Kyungki-do (KR)

(21) Appl. No.: 11/168,321

(22) Filed: Jun. 29, 2005

(30) Foreign Application Priority Data
Nov. 29, 2004 (KR) 10-2004-98904

(51) Int. Cl. F16C 32/06

(52) U.S. Cl. 384/114

(57) ABSTRACT

A spindle motor with a hydrodynamic pressure bearing is disclosed. The spindle motor with a hydrodynamic pressure bearing includes a stator having coils for generating electromagnetic force when electric power is applied to generate rotational driving force, a rotor rotated with respect to the stator and having magnets facing the winding coils, a hydrodynamic pressure generator having a shaft fixed to one of the stator and the rotor and a sleeve spaced apart from the shaft to face the shaft, at least one hydrodynamic pressure generating groove formed in one of the shaft and the sleeve, and at least one bearing load generator generating bearing load when the sleeve contacts the shaft and formed in one of the shaft and the sleeve. The spindle motor optimizes the shape of the sleeve and the shaft such that the spindle motor is stably rotated and vibration and noise can be reduced accordingly.

### RELATED APPLICATION

The present invention is based on, and claims priority from, Korean Application Number 2004-98904, filed Nov. 29, 2004, the disclosure of which is incorporated by reference herein in its entirety

### BACKGROUND OF THE INVENTION

1. Field of the Invention

The present invention relates to a spindle motor with a hydrodynamic pressure bearing, and more particularly to a spindle motor with a hydrodynamic pressure bearing for optimizing the shapes of a sleeve and a shaft such that the sleeve, when deviated to one side due to external shock, is returned to the vertical state using repulsive force caused by bearing load between components so that a motor is stably rotated and stable reduction of vibration and noise of the motor can be secured.

2. Description of the Related Art

Generally, in a motor employing a ball bearing, friction is generated due to balls' rolling by the rotation of the bearings, and the friction causes noise and vibration. The vibration is referred as to “Non Repeatable Run Out (NRRO)” and is one of the key obstacles to increasing the track density of hard disks.

On the other hand, since a spindle motor, which includes a hydrodynamic pressure bearing for maintaining stiffness of a shaft using only hydrodynamic pressure of fluid such as oil, air, or the like due to centrifugal force, is based on centrifugal force, there is no metal friction in the spindle motor. Since the stability of the spindle motor is increased as the rotational speed is increased, the spindle motor generates minimal noise and vibration. Moreover, since high speedy rotation is carried out much more easily using the spindle motor than a system employing ball bearings, the spindle motor is used almost exclusively for high end apparatuses such as high end optical disk drives, magnetic disk drives, hard disks, scanners, projectors, laser beam printers, or the like.

The hydrodynamic bearing, employed in the spindle motor characterized as described above, manages the high rotational speed of a motor to endure the external vibration and shock, and prevents the shaft from deviating from the vertical state.

In other words, the shaft serving as a rotation center or a metal sleeve that is assembled with the shaft and forms sliding surfaces has a herringbone- or spiral-groove for generating hydrodynamic pressure, and a fine gap formed on the sliding surfaces between the shaft and the sleeve are filled with a lubricant such as oil, air, or the like.

When the spindle motor is driven in the above state, the shaft does not contact the sleeve due to the hydrodynamic pressure generated from the groove formed in the sliding surfaces so that the frictional load is decreased and the spindle motor rotates without noise and vibration.

When the hydrodynamic pressure bearing having the above structure is employed in the spindle motor, since the fluid supports the rotation of a rotatable object, noise generated from the motor during the rotation of the motor is small, power consumption is decreased, and impact resistance of the motor is excellent.

FIG. 1 is a sectional view illustrating a conventional spindle motor having a hydrodynamic pressure bearing. As shown in the drawing, the conventional spindle motor 1 includes a base 12 in which a hollow cylindrical metal sleeve 32 is disposed at the central portion thereof, cores 14 inserted into and fixed to the outer surface of the sleeve 32, and coils 16 wound around the cores 14.

The conventional spindle motor 1 further includes a hub 22 integrated with and rotated together with a rotatable object 40 such as a turntable, or the like, which is mounted to apparatus employing the spindle motor 1 and disposed to the upper end of a shaft 34 inserted into an inner hole of the sleeve 32, and magnets 24 installed at the inner circumference of the hub 22 such that they face the coils 16 of the cores 14.

Moreover, in order to construct the hydrodynamic pressure bearing for supporting the shaft 34 as a rotational structure to rotate vertically with respect to the sleeve 32 as a fixed structure, a predetermined gap between the outer circumference of the shaft and the inner circumference of the sleeve 32 is formed, and a groove 36 for generating the hydrodynamic pressure is selectively formed in one of the outer circumference of the shaft 34 and the inner circumference of the sleeve 32.

As such, when electric power is applied, the shaft 34 rotates due to the interaction of the electric force generated from the coils 16 and the magnetic force generated from the magnets 24 in a predetermined direction, and a flow of the fluid such as oil, air, or the like, filling the groove 36 is concentrated to generate hydrodynamic pressure so that the shaft 34 rotates without contacting the inner circumference of the sleeve 32.

Namely, when the spindle motor 1 rotates normally, as shown in FIG. 2a, the central axis Y1 of the sleeve 32 and the rotation axis Y2 of the shaft 34 are aligned along the same vertical line, and the gap G between the sleeve 32 and the shaft 34 is maintained to a uniform in vertical direction so that the spindle motor 1 stably rotates.

However, when external impact is applied to the spindle motor 1 during the rotation of the spindle motor 1, as shown in FIGS. 2b and 2c, the sleeve 32 assembled to the shaft 34 is slanted toward the direction where the external impact is applied (right side or left side as seen in the drawings), so that the central axis Y1 of the sleeve 32 is slanted at an angle θ1 or θ2 with respect to the vertical rotation axis Y2 of the shaft 34.

In this case, the upper or lower end of the sleeve 32 slanted by the external impact is partially line-contacted with the upper or lower end outer circumference of the shaft 34 as a rotational component, so that the line-contact between the metal components generates noise to deteriorate the performance of the spindle motor 1.

Moreover, if abrasion due to the contact between the metal components is increased to generate high temperature at the contacting portion of the metal components, fusion that the contacting portions are burnt or overheated by the heat and the metal components stick or are welded to each other occurs. As a result, the rotation of the motor is stopped.

In order to overcome the above problem, the gap G between the sleeve 32 and the shaft 34 must be remarkably reduced from a normal value, that is, about 5 μm to a value of 1 μm to 2 μm so as to assemble the sleeve 32 with the shaft 34. In this case, since the inner circumference of the sleeve 32 and the outer circumference of the shaft 34 must be precisely fabricated according to the minimal dimensional gap, it is difficult to fabricate the components and costs for the fabrication are excessive so that costs for manufacturing the spindle motor are increased.

Further, if the gap G between the sleeve 32 and the shaft 34 is remarkably reduced, since the groove 36 formed in the sliding surfaces between the sleeve 32 and the shaft 34 cannot generate sufficient hydrodynamic pressure, the spindle motor cannot be stably rotated.

### SUMMARY OF THE INVENTION

Therefore, the present invention has been made in view of the above problems, and it is an object of the present invention to provide a spindle motor with a hydrodynamic pressure bearing for returning the sleeve slanted in a direction due to external shock to the vertical state using repulsive force caused by bearing load between components so that the spindle motor is stably rotated and stable reduction of vibration and noise of the motor can be secured.

In accordance with an object of the present invention, the above and other objects can be accomplished by the provision of a spindle motor with a hydrodynamic pressure bearing includes a stator including winding coils for generating electromagnetic force when electric power is applied to generate rotational driving force, a rotor rotated with respect to the stator and including magnets facing the winding coils, a hydrodynamic pressure generator including a shaft fixed to one of the stator and the rotor and a sleeve spaced apart from the shaft to face the shaft, at least one hydrodynamic pressure generating groove formed in one of the shaft and the sleeve, and at least one bearing load generator generating bearing load when the sleeve contacts the shaft and formed in one of the shaft and the sleeve.

Preferably, the bearing load generator includes an outer circumferential upper taper having a cross-section whose diameter is gradually narrower from the upper end of the hydrodynamic pressure generator formed at the shaft to the upper side of the shaft, and an outer circumferential lower taper having a cross-section whose diameter is gradually narrower from the lower end of the hydrodynamic pressure generator to the lower side of the shaft.

The hydrodynamic pressure generator is formed at the central portion of the sleeve in the longitudinal direction.

The outer circumferential upper and lower tapers are symmetrically formed around the hydrodynamic pressure generator.

Moreover, the length of the hydrodynamic pressure generator is longer than those of the outer circumferential upper and lower tapers, and the ratio of lengths of the outer circumferential upper taper, the hydrodynamic pressure generator, and the outer circumferential lower taper is 1:2:1 with respect to the longitudinal direction.

Preferably, the outer circumferential upper and lower tapers are slanted at a same angle with respect to a vertical axis.

The outer circumferential upper and lower tapers respectively have upper and lower interference blocking part having cross-sections whose diameters are extended from the minimal diameter of the outer circumferential upper and lower tapers to the maximal outer diameter of the shaft.

In order to accomplish the object of the present invention, the present invention also provides a spindle motor with a hydrodynamic pressure bearing including a stator including a core around which at least one winding coil is wound and a base in which a sleeve is vertically installed on the upper side of the base, a rotor rotated with the stator and including a hub, in which magnets are spaced apart from the core to be integrated with the core, and a shaft rotatably assembled with the sleeve, a hydrodynamic pressure generator including at least one hydrodynamic pressure generating groove formed one of the inner circumference of the sleeve and the outer circumference of the shaft, and a bearing load generator for generating bearing load when the sleeve contacts the shaft, wherein the bearing load generator includes an outer circumferential upper taper formed in the upper outer circumference of the shaft and having a cross-section whose diameter is gradually narrower from the upper end of the hydrodynamic pressure generator to the upper side of the shaft, and an outer circumferential lower taper formed in the lower outer circumference of the shaft and having a cross-section whose diameter is gradually narrower from the lower end of the hydrodynamic pressure generator to the lower side of the shaft.

The hydrodynamic pressure generator is formed at the central portion of the sleeve in the longitudinal direction.

The outer circumferential upper and lower tapers are symmetrically formed around the hydrodynamic pressure generator.

Moreover, the length of the hydrodynamic pressure generator is longer than those of the outer circumferential upper and lower tapers, and the ratio of lengths of the outer circumferential upper taper, the hydrodynamic pressure generator, and the outer circumferential lower taper is 1:2:1 with respect to the longitudinal direction.

Preferably, the outer circumferential upper and lower tapers are slanted at a same angle with respect to a vertical axis.

The outer circumferential upper and lower tapers respectively have upper and lower interference blocking part having cross-sections whose diameters are extended from the minimal diameter of the outer circumferential upper and lower tapers to the maximal outer diameter of the shaft.

In accordance with an object of the present invention, the above and other objects can be accomplished by the provision of a spindle motor with a hydrodynamic pressure bearing including a stator including a core around which at least one winding coil is wound and a base in which a sleeve is vertically installed on the upper side of the base, a rotor rotated with the stator and including a hub, in which magnets are spaced apart from the core to be integrated with the core, and a shaft rotatably assembled with the sleeve, a hydrodynamic pressure generator including at least one hydrodynamic pressure generating groove formed in the inner circumference of the sleeve or in the outer circumference of the shaft, and a bearing load generator for generating bearing load when the sleeve contacts the shaft, wherein the bearing load generator includes an inner circumferential upper taper formed in the upper inner circumference of the sleeve and having a cross-section whose diameter is gradually widened from the upper end of the hydrodynamic pressure generator to the upper side of the shaft, and an inner circumferential lower taper formed in the lower inner circumference of the sleeve and having a cross-section whose diameter is gradually widened from the lower end of the hydrodynamic pressure generator to the lower side of the shaft.

Preferably, the hydrodynamic pressure generator is formed at the central portion of the sleeve in the longitudinal direction.

The inner circumferential upper and lower tapers are symmetrically formed around the hydrodynamic pressure generator.

Moreover, the length of the hydrodynamic pressure generator is longer than those of the inner circumferential upper and lower tapers, and the ratio of lengths of the inner circumferential upper taper, the hydrodynamic pressure generator, and the inner circumferential lower taper is 1:2:1 with respect to the longitudinal direction.

Preferably, the inner circumferential upper and lower tapers are slanted at a same angle with respect to a vertical axis.

### BRIEF DESCRIPTION OF THE DRAWINGS

These and/or other objects and advantages of the present invention will become apparent and more readily appreciated from the following description of the embodiments, taken in conjunction with the accompanying drawings, in which:

FIG. 1 is a sectional view of a conventional spindle motor having a hydrodynamic pressure bearing;

FIG. 2 illustrates the rotation of the conventional spindle motor having a hydrodynamic pressure bearing, in which:

FIG. 2a is a view illustrating normal rotation of the conventional spindle motor; and

FIGS. 2b and 2c are views illustrating a sleeve slanted by an external impact;

FIG. 3 is a view illustrating an appearance of a shaft employed in a spindle motor having a hydrodynamic pressure bearing according to a first embodiment of the present invention;

FIG. 4 is a sectional view of the spindle motor having a hydrodynamic pressure bearing according to the first embodiment of the present invention;

FIG. 5 illustrates the rotation of the spindle motor having a hydrodynamic pressure bearing according to the first embodiment of the present invention, in which:

FIG. 5a is a view illustrating a normal rotation of the spindle motor having a hydrodynamic pressure bearing according to the first embodiment of the present invention; and

FIGS. 5b and 5c are views illustrating a sleeve slanted by an external impact;

FIG. 6 is a view illustrating an appearance of a sleeve employed in a spindle motor having a hydrodynamic pressure bearing according to a second embodiment of the present invention;

FIG. 7 is a sectional view illustrating the spindle motor having a hydrodynamic pressure bearing according to the second embodiment of the present invention; and

FIG. 8 illustrates the rotation of the spindle motor having a hydrodynamic pressure bearing according to the second embodiment of the present invention, in which:

FIG. 8a is a view illustrating normal rotation of the spindle motor having a hydrodynamic pressure bearing according to the second embodiment of the present invention; and

FIGS. 8b and 8c are views illustrating a sleeve slanted by an external impact.

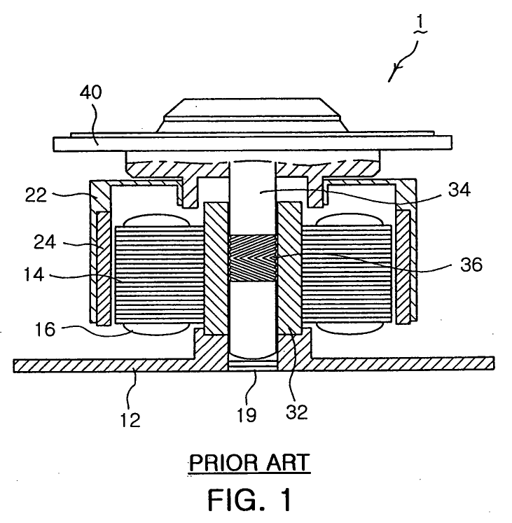

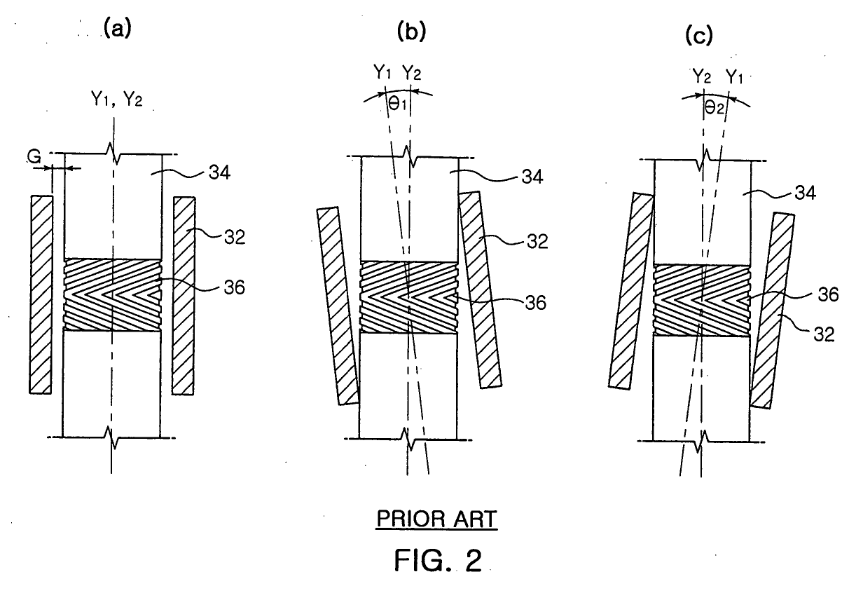

### DESCRIPTION OF THE PREFERRED EMBODIMENTS

Hereinafter, the present invention will be described in detail with reference to the accompanying drawings as follows.

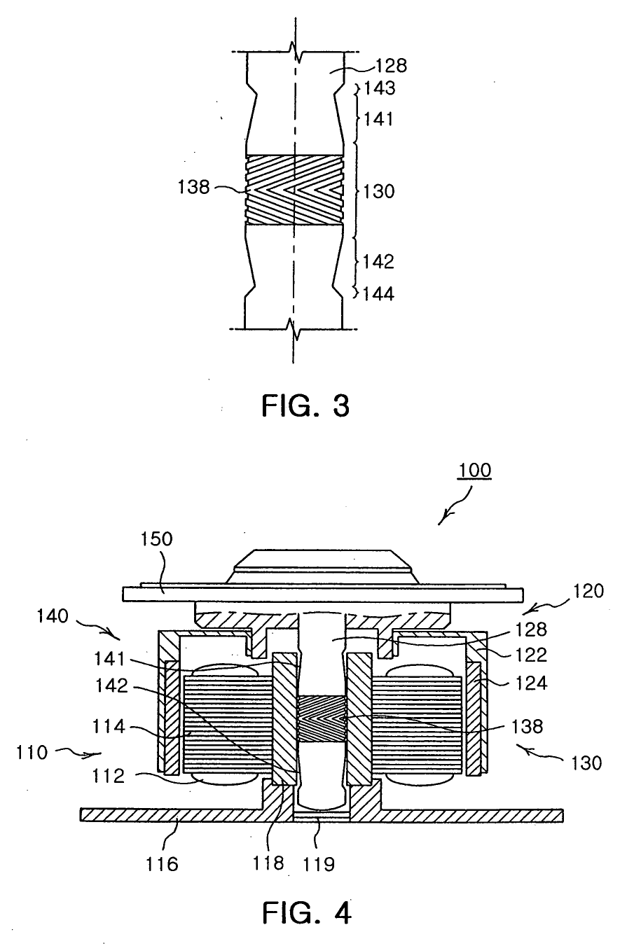

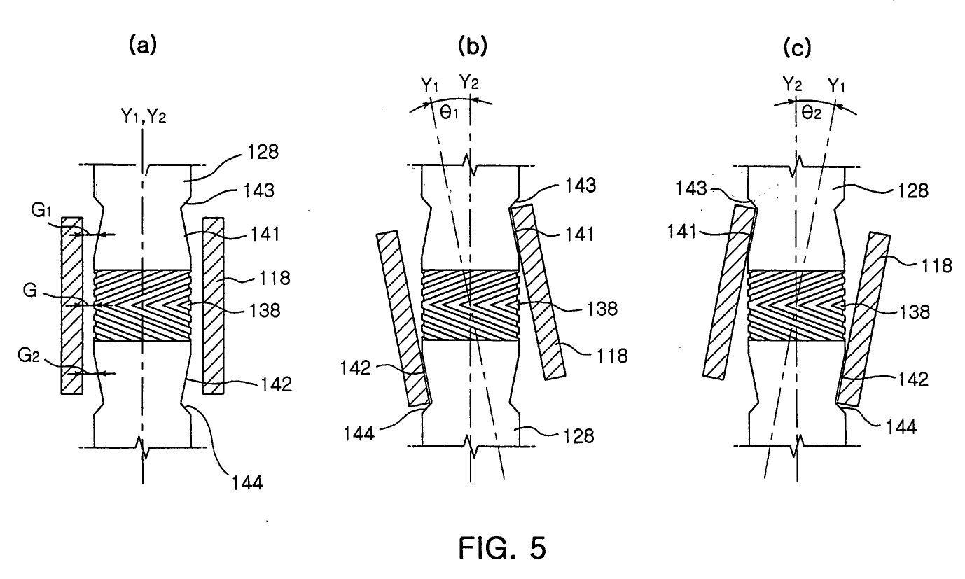

FIG. 3 is a view illustrating an appearance of a shaft employed in a spindle motor having a hydrodynamic pressure bearing according to a first embodiment of the present invention, FIG. 4 is a sectional view of the spindle motor having a hydrodynamic pressure bearing according to the first embodiment of the present invention, and FIGS. 5a, 5b, and 5c illustrate the rotation of the spindle motor having a hydrodynamic pressure bearing according to the first embodiment of the present invention.

The spindle motor 100, as shown in FIGS. 3 to 5, converts the line-contact between metal components due to an external impact into the surface-contact between the metal components so as to return the metal components slanted by an external impact to the vertical state, and includes a stator 110, a rotor 120, a hydrodynamic pressure generator 130, and a surface-pressure bearing load generator 140.

In other words, the stator 110 is a structure that includes winding coils for generating a predetermined electric field when electric power is applied and cores 114 radially extended from a pole around which at least one of the winding coils 112 is wound.

Moreover, the cores 114 are fixed to the upper side of the base 116 having a printed circuit board (not shown), a hollow cylindrical sleeve 118 is vertically disposed on the upper side of the base 116, and an open lower end of the sleeve 118 is closed by an end plate 119.

Here, the cores 114, as shown in FIG. 4, may be integrated with the outer circumference of the sleeve 118, not limited to the outer circumference, or may be disposed on a holder disposed on the upper central portion of the base 116 and to which the sleeve 118 is fixed.

The rotor 120 is a structure rotating with respect to the stator 110, and includes ring-shaped magnets 124 spaced apart from the ends of the cores 114 to face the cores 114. The cores 114 are integrated with a cup-shaped hub 122 having an opened lower side and surrounding the cores 114 and the sleeves 118 from the upper sides to the lower sides thereof.

The magnets 124 include permanent magnets of which N-poles and S-poles are alternately attached in the radial direction so as to generate magnetic force with a predetermined intensity.

On the vertical axis about which the rotational center of the hub 122 is aligned, a shaft 128 of predetermined length is rotatably inserted into the inner hole of the sleeve 118. The upper end of the shaft 128 is integrally connected to the lower side of the rotatable object 150, and the hub 122 is integrally connected to the rotatable object 150. As such, the hub 122 and the rotatable object 150 rotate together with the shaft 128 in a predetermined direction when the motor is driven.

Here, the rotatable object 150, as shown in FIG. 4, may include a turntable on which a disc is loaded. However the present invention is not limited to this and, accordingly, may include a variety of devices according to the apparatus to which the spindle motor 100 is applied.

Moreover, the hydrodynamic pressure generator 130 for generating the hydrodynamic pressure on the sliding surfaces between the sleeve 118 and the shaft 120 includes the hydrodynamic pressure generating groove 138 formed in at least one of the inner circumference of the sleeve 118 and the outer circumference of the shaft 128.

The hydrodynamic pressure generating groove 138, which may be formed in a herringbone or spiral shaped, is filled with fluid such as oil, air, or the like, supplied to the gap G finely formed between the sleeve 118 and the shaft 128.

As such, the fluid filling the groove 139 formed in the hydrodynamic pressure generator 130 generates an oil film by receiving a strong pressure, so that the sliding surfaces between the sleeve 118 and the shaft 128 are in a fluid frictional state where the frictional load is minimized. As a result, the spindle motor 100 rotates without noise and vibration.

At this time, the hydrodynamic pressure generating groove 138 is preferably provided in the intermediate portion of the sleeve 118 in the longitudinal direction such that the hydrodynamic pressure generator 130 for generating the hydrodynamic pressure can be formed in the intermediate portion of the sleeve 118 in the longitudinal direction.

Meanwhile, the bearing load generator 140 for generating bearing load at the contacting portion when the sleeve 118 contacts the shaft 128 due to the external impact includes an outer circumferential upper taper 141 and an outer circumferential lower taper 142. The outer circumferential upper taper 141 is formed on the upper outer circumference of the shaft 128 corresponding to the upper end of the sleeve 118 such that the outer circumferential upper taper 141 has a diameter of the outer circumferential upper taper 141 is gradually narrower from the upper end of the hydrodynamic pressure generator 140 to its upper side of the outer circumferential upper taper 141. In other words, the cross-sectional area of the outer circumferential upper taper 141 is gradually decreased as going to its upper side.

The outer circumferential lower taper 142 is formed on the lower outer circumference of the shaft 128 corresponding to the lower end of the sleeve 118 such that the outer circumferential lower taper 142 has a diameter of the outer circumferential upper taper 141 is gradually narrower from the lower end of the hydrodynamic pressure generator 140 to its lower side of the outer circumferential upper taper 141. In other words, the cross-sectional area of the outer circumferential upper taper 141 is gradually decreased as going to its lower side.

As such, the gap G between the sleeve 118 and the shaft 128 that serves as the hydrodynamic pressure generator 130 maintains a predetermined value to be formed in the longitudinal direction of the sleeve 118, while an upper gap G1 formed at the outer circumferential upper taper 141 between the sleeve 118 and the shaft 128 increases in width towards the upper side of the shaft 128 and a lower gap G2 formed at the outer circumferential lower taper 142 between the sleeve 118 and the shaft 128 is gradually narrower as going to the lower side of the shaft 128.

Preferably, the outer circumferential upper and lower tapers 141 and 142 are symmetric with respect to the hydrodynamic pressure generator 130 such that the bearing loads at the upper and lower gaps G1 and G2 are approximately identical to each other when the sleeve 118 contacts the shaft 128.

The hydrodynamic pressure generator 130 is preferably longer than lengths of the outer circumferential upper and lower tapers 141 and 142 such that the region where the hydrodynamic pressure is generated is larger than the region where the bearing load is generated. To this end, the ratio of lengths of the outer circumferential upper taper 141, the hydrodynamic pressure generator 130, and the outer circumferential lower taper 142 is preferably 1:2:1 with respect to the longitudinal direction of the sleeve 118.

Preferably, the outer circumferential upper and lower tapers 141 and 142 respectively have upper and lower interference blocking part 143 and 144 whose diameters are increased from the minimal diameters of the outer circumferential upper and lower tapers 141 and 142 to the maximal diameter of the shaft 128, such that the upper and lower edges of the sleeve 118 do not contact the outer circumference of the shaft 128 when the sleeve 118 contacts the shaft 128.

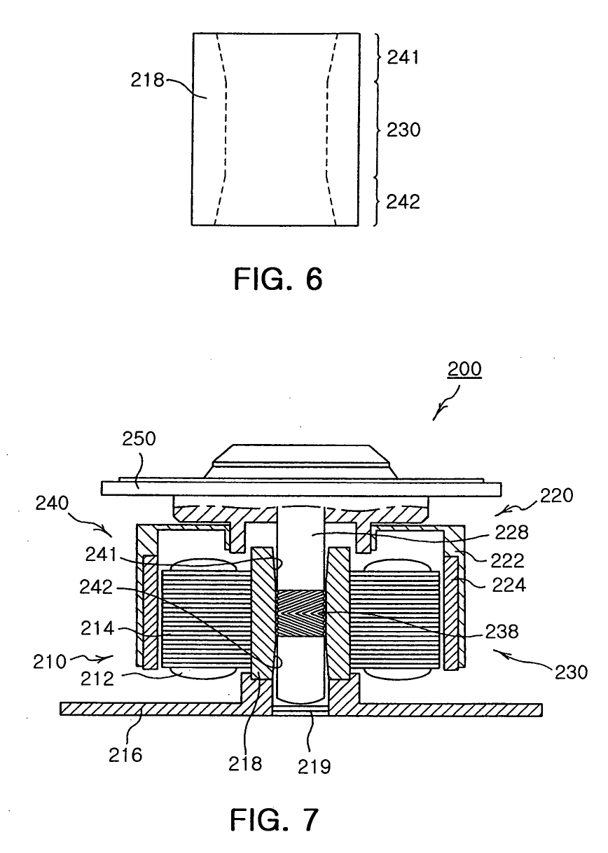

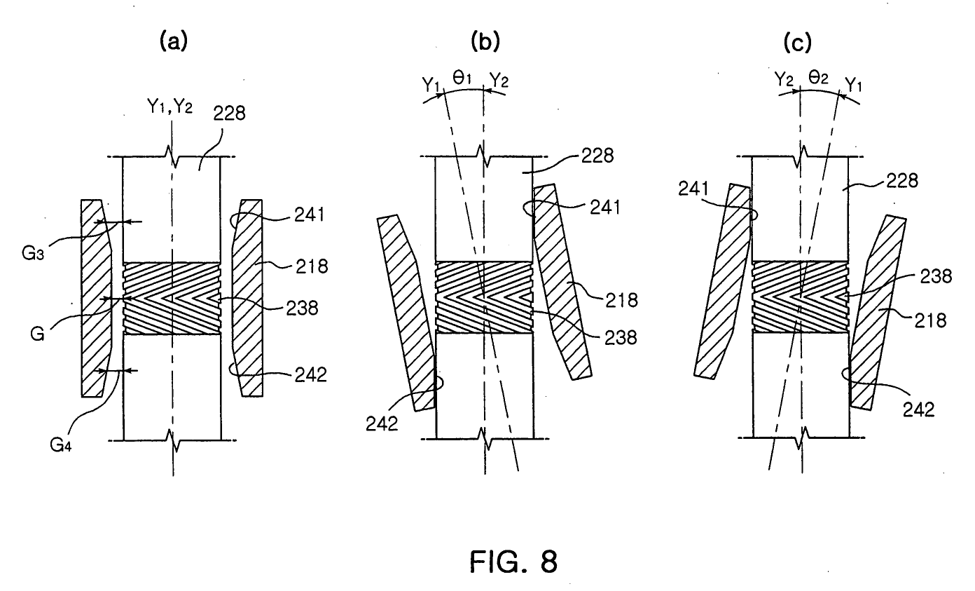

FIG. 6 is a view illustrating the appearance of a sleeve employed in a spindle motor having a hydrodynamic pressure bearing according to a second embodiment of the present invention, FIG. 7 is a sectional view illustrating the spindle motor having a hydrodynamic pressure bearing according to the second embodiment of the present invention, and FIGS. 8a, 8b, and 8c are views illustrating the rotation of the spindle motor having a hydrodynamic pressure bearing according to the second embodiment of the present invention.

The spindle motor 200 having a hydrodynamic pressure bearing according to the second embodiment of the present invention, as shown in FIGS. 6 and 7, like the spindle motor 100 according to the first embodiment of the present invention, includes a stator 210, a rotor 220, a hydrodynamic pressure generator 230, and a bearing load generator 240. Since the stator 210, the rotor 220, and the hydrodynamic pressure generator 230 are identical to those of the spindle motor 100 according to the first embodiment of the present invention, same reference numerals are assigned to same components by adding 100 to the reference numerals assigned to the components of spindle motor according the previous embodiment, and their description will be omitted.

In other words, in the bearing load generator 240, an inner circumferential upper taper 241 and an inner circumferential lower taper 242 are formed in the inner circumference of the sleeve 218 such that the bearing load is generated on the contacting portion between the sleeve 218 and the shaft 228 when the sleeve 218 contacts the shaft 228 due to the external impact.

The inner circumferential upper taper 241 is slanted in the upper inner circumference of the sleeve 218 so as to have a cross-section such that the inner diameter of the inner circumferential upper taper 241 is gradually increased from the upper end of the hydrodynamic pressure generator 240 to the upper side of the inner circumferential upper taper 241.

The inner circumferential lower taper 242 is slanted in the lower inner circumference of the sleeve 218 so as to have a cross-section such that the inner diameter of the inner circumferential upper taper 242 is gradually increased from the lower end of the hydrodynamic pressure generator 240 to the lower side of the inner circumferential upper taper 241.

As such, the gap G between the sleeve 218 and the shaft 228 as the hydrodynamic pressure generator 230, as shown in FIG. 8a, is maintained at a predetermined value in the longitudinal direction of the sleeve 218, while an upper gap G3 formed at the inner circumferential upper taper 241 between the sleeve 218 and the shaft 228 is widened as going to the upper side of the shaft 228 and, a lower gap G4 formed at the inner circumferential lower taper 242 between the sleeve 218 and the shaft 228 is decreased as going to the lower side of the shaft 228.

Preferably, the inner circumferential upper and lower tapers 241 and 242 are formed in the symmetrical manner with respect to the hydrodynamic pressure generator 230 such that the bearing loads at the upper and lower gaps G3 and G4 are approximately identical to each other when the sleeve 218 contacts the shaft 228.

The length of the hydrodynamic pressure generator 230 is preferably longer than those of the inner circumferential upper and lower tapers 241 and 242 such that the region where the hydrodynamic pressure is generated is larger than the region where the bearing load is generated. To this end, the ratio of lengths of the inner circumferential upper taper 241, the hydrodynamic pressure generator 230, and the inner circumferential lower taper 242 is preferably 1:2:1 with respect to the longitudinal direction of the sleeve 218.

The spindle motors 100 and 200 according to the present invention, as shown in FIGS. 4 and 7, rotate the rotatable structures, that is, the rotors 120 and 220 assembled with the fixed structures, that is, the stators 110 and 210 in same manner when the electric power is applied, the rotational operation of the spindle motors 100 and 200 will be described with reference to the spindle motor 100 according to the first embodiment shown in FIG. 4.

An electric field with a predetermined intensity is generated by the winding coils 112 when electric power is applied to the winding coils 112 of the stator 110. The electric field generated by the winding coils 112 interacts with the magnetic field generated from the magnets 124 of the rotor 120 so as to rotate the shaft 128, in which the hub 122 of the rotor 120 is rotatably installed to the sleeve 118, with respect to the rotation axis in a predetermined direction.

When the rotor 120 rotates in the predetermined direction, since the hydrodynamic pressure generator 130 has at least one hydrodynamic pressure generating groove 139 formed in one of the sliding surfaces between the inner circumference of the sleeve 118 and the outer circumference of the shaft 128, the fluid filling the groove 138 receives a strong pressure so as to form the fluid film.

As such, in the gap G where the hydrodynamic pressure generator 130 is formed, lubricant film for minimizing the frictional load to remove noise and vibration is formed so that the spindle motor 100 can be smoothly rotated.

When external impact is applied while the center axes Y1 of the sleeves 118 and 218 and the rotational axes Y2 of the shafts 128 and 228 are vertically aligned and the spindle motors 100 and 200, as shown in FIGS. 5a and 8a, rotate in the normal state, the sleeves 118 and 218, as shown in FIGS. 5b, 5c, 8b, and 8c, are slanted in the direction where the external impact is applied (right or left as seen in the drawings) so that the center axes Y1 of the sleeves 118 and 218 are slanted at angles θ1 and θ2 with respect to the rotational axes Y2 of the vertical shafts 128 and 228.

In the case that the bearing load generators 140 including the outer circumferential upper and lower tapers 141 and 142 are respectively formed in the outer circumferences of the shaft 128 which is assembled with the sleeve 118 that is instantly slanted in a certain direction, as shown in FIGS. 5b and 5c, the upper inner circumference and lower inner circumference of the slanted sleeve 118 respectively face-contact the slanted outer circumference of the outer circumferential upper taper 141 and the slanted outer circumference of the outer circumferential lower taper 142, while the face-contact between the sleeve 118 and the shaft 128 occurs at the outer circumferential upper and lower tapers 141 and 142, simultaneously.

In this case, strong bearing load is generated at the face-contact regions between the sleeve 118 and the outer circumferential upper and lower tapers 141 and 142, which face-contact each other, and the slanted sleeve 118 can be restored to the original vertical state by the repulsive force due to the strong bearing load. As such, the initial normal rotating states of the spindle motors 100 and 200 can be maintained, and noise and vibration due to the contact between metal components can be prevented.

Since the outer circumferential upper and lower tapers 141 and 142 respectively have the upper and lower interference blocking part 143 and 144 having the cross-sections whose diameters are gradually increased to the size of the maximal outer diameter of the shaft 128, the outer circumference upper and lower tapers 141 and 142 prevent the upper and lower edges of the sleeve 118 slanted when the sleeve 118 face-contacts the shaft 128 from contacting the outer circumferences with the maximal diameter of shaft 128 so as to secure the stable face-contact of the sleeve 119 with the outer circumferential upper and lower tapers 141 and 142.

Meanwhile, in the case that the bearing load generators 240 including the inner circumferential upper and lower tapers 241 and 242, as shown in FIGS. 8b and 8c, are respectively formed in the inner circumference of the sleeve 218 instantly slanted in a certain direction, the inner circumferential upper and lower tapers 241 and 242 of the slanted sleeve 218 face-contact the outer circumference with a uniform diameter of the shaft, and the face-contacts of the sleeve 218 with the shaft 228 occur at the inner circumferential upper and lower tapers 241 and 242, simultaneously.

In this case, like the above case, strong bearing load is generated at the face-contacting regions between the sleeve 218 and the inner circumferential upper and lower tapers 241 and 242, which face-contact each other, and the slanted sleeve 218 can be restored to the original vertical state by the repulsive force due to the strong bearing load. As such, the initial normal rotating states of the spindle motors 100 and 200 can be maintained, and noise and vibration due to the contact between metal components can be prevented.

As described above, according to the present invention, the upper and lower tapers for expanding the gap between the sleeve and the shaft are formed at the upper and lower sides of the hydrodynamic pressure generator around the hydrodynamic pressure generator so that the sleeve slanted in a certain 15 direction due to the external impact face-contacts the shaft maintaining the vertical state so as to generate the bearing load. Since the slanted sleeve can be restored to the original state by the repulsive force generated by the bearing load, the spindle motor maintains normal rotation regardless of poorer external circumstance, the lifespan of the spindle motor can be extended, and vibration and noise can be remarkably reduced. Thus, high-end spindle motors can be manufactured.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A spindle motor with a hydrodynamic pressure bearing comprising:
a stator including winding coils for generating electromagnetic force when electric power is applied to generate rotational driving force;
a rotor rotated with respect to the stator and including magnets facing the winding coils;
a hydrodynamic pressure generator including a shaft fixed to one of the stator and the rotor and a sleeve spaced apart from the shaft to face the shaft;
at least one hydrodynamic pressure generating groove formed in one of the shaft and the sleeve; and
at least one bearing load generator generating bearing load when the sleeve contacts the shaft and formed in one of the shaft and the sleeve.

2. The spindle motor with a hydrodynamic pressure bearing as set forth in claim 1, wherein the bearing load generator comprises:
an outer circumferential upper taper having a cross-section whose diameter is gradually narrower from the upper end of the hydrodynamic pressure generator formed at the shaft to the upper side of the shaft; and
an outer circumferential lower taper having a cross-section whose diameter is gradually narrower from the lower end of the hydrodynamic pressure generator to the lower side of the shaft.

3. The spindle motor with a hydrodynamic pressure generator as set forth in claim 1, wherein the hydrodynamic pressure generator is formed at the central portion of the sleeve in the longitudinal direction.

4. The spindle motor with a hydrodynamic pressure bearing as set forth in claim 2, wherein the outer circumferential upper and lower tapers are symmetrically formed around the hydrodynamic pressure generator.

5. The spindle motor with a hydrodynamic pressure as set forth in claim 2, wherein the length of the hydrodynamic pressure generator is longer than those of the outer circumferential upper and lower tapers.

6. The spindle motor with a hydrodynamic pressure bearing as set forth in claim 5, wherein the ratio of lengths of the outer circumferential upper taper, the hydrodynamic pressure generator, and the outer circumferential lower taper is 1:2:1 with respect to the longitudinal direction.

7. The spindle motor with a hydrodynamic pressure bearing as set forth in claim 2, wherein the outer circumferential upper and lower tapers are slanted at a same angle with respect to a vertical axis.

8. The spindle motor with a hydrodynamic pressure bearing as set forth in claim 2, wherein the outer circumferential upper and lower tapers respectively have upper and lower interference blocking part having cross-sections whose diameters are extended from the minimal diameter of the outer circumferential upper and lower tapers to the maximal outer diameter of the shaft.

9. A spindle motor with a hydrodynamic pressure bearing comprising:
a stator including a core around which at least one winding coil is wound and a base in which a sleeve is vertically installed on the upper side of the base;
a rotor rotated with the stator and including a hub, in which magnets are spaced apart from the core to be integrated with the core, and a shaft rotatably assembled with the sleeve;
a hydrodynamic pressure generator including at least one hydrodynamic pressure generating groove formed one of the inner circumference of the sleeve and the outer circumference of the shaft; and
a bearing load generator for generating bearing load when the sleeve contacts the shaft, the bearing load generator including:
an outer circumferential upper taper formed in the upper outer circumference of the shaft and having a cross-section whose diameter is gradually narrower from the upper end of the hydrodynamic pressure generator to the upper side of the shaft; and
an outer circumferential lower taper formed in the lower outer circumference of the shaft and having a cross-section whose diameter is gradually narrower from the lower end of the hydrodynamic pressure generator to the lower side of the shaft.

10. The spindle motor with a hydrodynamic pressure bearing as set forth in claim 9, wherein the hydrodynamic pressure generator is formed at the central portion of the sleeve in the longitudinal direction.

11. The spindle motor with a hydrodynamic pressure bearing as set forth in claim 9, wherein the outer circumferential upper and lower tapers are symmetrically formed around the hydrodynamic pressure generator.

12. The spindle motor with a hydrodynamic pressure bearing as set forth in claim 9, wherein the length of the hydrodynamic pressure generator is longer than those of the outer circumferential upper and lower tapers.

13. The spindle motor with a hydrodynamic pressure bearing as set forth in claim 12, wherein the ratio of lengths of the outer circumferential upper taper, the hydrodynamic pressure generator, and the outer circumferential lower taper is 1:2:1 with respect to the longitudinal direction.

14. The spindle motor with a hydrodynamic pressure bearing as set forth in claim 9, wherein the outer circumferential upper and lower tapers are slanted at a same angle with respect to a vertical axis.

15. The spindle motor with a hydrodynamic pressure bearing as set forth in claim 9, wherein the outer circumferential upper and lower tapers respectively have upper and lower interference blocking part having cross-sections whose diameters are extended from the minimal diameter of the outer circumferential upper and lower tapers to the maximal outer diameter of the shaft.

16. A spindle motor with a hydrodynamic pressure bearing comprising:
a stator including a core around which at least one winding coil is wound and a base in which a sleeve is vertically installed on the upper side of the base;
a rotor rotated with the stator and including a hub, in which magnets are spaced apart from the core to be integrated with the core, and a shaft rotatably assembled with the sleeve;
a hydrodynamic pressure generator including at least one hydrodynamic pressure generating groove formed in the inner circumference of the sleeve or in the outer circumference of the shaft; and
a bearing load generator for generating bearing load when the sleeve contacts the shaft, the bearing load generator including:
an inner circumferential upper taper formed in the upper inner circumference of the sleeve and having a cross-section whose diameter is gradually widened from the upper end of the hydrodynamic pressure generator to the upper side of the shaft; and
an inner circumferential lower taper formed in the lower inner circumference of the sleeve and having a cross-section whose diameter is gradually widened from the lower end of the hydrodynamic pressure generator to the lower side of the shaft.

17. The spindle motor with a hydrodynamic pressure bearing as set forth in claim 16, wherein the hydrodynamic pressure generator is formed at the central portion of the sleeve in the longitudinal direction.

18. The spindle motor with a hydrodynamic pressure bearing as set forth in claim 16, wherein the inner circumferential upper and lower tapers are symmetrically formed around the hydrodynamic pressure generator.

19. The spindle motor with a hydrodynamic pressure bearing as set forth in claim 16, wherein the length of the hydrodynamic pressure generator is longer than those of the inner circumferential upper and lower tapers.

20. The spindle motor with a hydrodynamic pressure bearing as set forth in claim 19, wherein the ratio of lengths of the inner circumferential upper taper, the hydrodynamic pressure generator, and the inner circumferential lower taper is 1:2:1 with respect to the longitudinal direction.

21. The spindle motor with a hydrodynamic pressure bearing as set forth in claim 16, wherein the inner circumferential upper and lower tapers are slanted at a same angle with respect to a vertical axis.
